(19) United States
(12) Patent Application Publication
(10) Pub. No.: US 2022/0408777 A1
(43) Pub. Date: Dec. 29, 2022

(54) FOOD COMPOSITION FOR PREVENTING AND AMELIORATING DIABETES COMPRISING FERMENTED NONI AND METHOD FOR PREPARING SAME

(71) Applicant: NSTBIO. CO., LTD., Gimpo-si (KR)

(72) Inventors: Eun Young PARK, Gimpo-si (KR); Geum Su SEONG, Gimpo-si (KR); Im Joung LA, Gimpo-si (KR)

(73) Assignee: NSTBIO. CO., LTD., Gimpo-si (KR)

(21) Appl. No.: 17/823,657

(22) Filed: Aug. 31, 2022

Related U.S. Application Data
(63) Continuation of application No. PCT/KR2020/019217, filed on Dec. 28, 2020.

(30) Foreign Application Priority Data
Mar. 2, 2020 (KR) 10-2020-0026252

(51) Int. Cl. A23L 33/135; A23L 21/15; A23L 33/105

(52) U.S. Cl. CPC A23L 33/135; A23L 21/15; A23L 33/105

(57) ABSTRACT

The present invention relates to a food composition for preventing and ameliorating diabetes, comprising fermented noni, and a method for preparing the same. More specifically, fermented noni prepared by inoculating complex lactic acid bacteria containing 7 types of lactic acid bacteria comprises scopoletin, deacetylasperulosidic acid, and asperulosidic acid, which are produced by bioconversion, and a food composition for preventing and ameliorating diabetes, comprising fermented noni containing all of the three components may exhibit an effect of preventing and ameliorating diabetes by lowering blood glucose.

### CROSS-REFERENCE TO RELATED APPLICATIONS

This application is a Continuation of International Application No. PCT/KR2020/019217, filed on Dec. 28, 2020, which claims benefit of priority to Korean Patent Application No. 10-2020-0026252, filed on Mar. 2, 2020, the entire content of which is incorporated herein by reference.

### TECHNICAL FIELD

The present invention relates to a food composition for preventing and ameliorating diabetes including fermented noni and a method for preparing the same.

### BACKGROUND ART

In general, industry is rapidly developing, the living culture and environment of modern people are changing rapidly due to modernization, and as the mental and physical activities that accompany it increase, stress increases, and various types of adult diseases as well as physical weakness due to indigestion and metabolic incongruity of the human body are appearing. Further, the dietary culture changes due to busy life, the amount of exercise decreases, the intake of instant foods and high-fat foods increases, so that problems leading to hypertension, constipation, diabetes, and obesity have appeared.

In particular, diabetes is a disease characterized by hyperglycemia that appears due to insufficient insulin secretion in the pancreas and abnormal insulin action in each tissue, and is a disease that causes various serious complications such as diabetic neurological diseases including vascular system-related diseases such as hypertension and arteriosclerosis, retinopathy, cataracts, and kidney diseases.

Various health functional foods have emerged as a new target of interest for the prevention of such diabetes. In other words, health functional foods have been developed with the aim of promoting health and preventing and treating diseases based on the passive concept of simple foods that maintain our body.

Recently, although noni has been attracting attention as a food raw material in various forms due to its excellent detoxification action, the field of utilization of noni is still limited, so that there is a continuous need for technological development capable of applying noni to a wider range of uses.

In particular, when various beneficial components are produced by inoculating lactic acid bacteria into noni to induce bioconversion, bioconversion components capable of being effective in preventing or ameliorating diabetes may be formed, so that it is possible to develop a composition for preventing or ameliorating diabetes using the bioconversion components.

### RELATED ART DOCUMENTS

### Patent Documents

(Patent Document 0001) Korean Patent No. 1883154

(Patent Document 0002) Korean Patent Application Laid-Open No. 2013-0073048

### DISCLOSURE

### Technical Problem

As a result of conducting multifaceted research to solve the above problems, the present inventors confirmed that fermented noni produced by inoculating complex lactic acid bacteria including 7 types of lactic acid bacteria into the fermented noni includes scopoletin, deacetylasperulosidic acid and asperulosidic acid produced by bioconversion, and fermented noni including all three of these components can not only prevent diabetes but also lower blood glucose of existing patients with diabetes.

Therefore, an object of the present invention is to provide a food composition for preventing and ameliorating diabetes, including fermented noni.

In addition, another object of the present invention is to provide a method for preparing a food composition for preventing and ameliorating diabetes, including fermented noni.

### Technical Solution

To achieve the aforementioned objects, the present invention provides a food composition for preventing and ameliorating diabetes, including fermented noni inoculated with lactic acid bacteria.

The fermented noni inoculated with lactic acid bacteria may be included in an amount of 1 to 10 wt % based on the total weight of the food composition.

The fermented noni may be a fermented product in which one or more of the following 7 types of lactic acid bacteria are inoculated into noni fruit:

(1) Lactobacillus plantarum;

(2) Bifidobacterium lactis;

(3) Lactobacillus rhamnosus;

(4) Lactobacillus casei;

(5) Lactobacillus fermentum;

(6) Bifidobacterium breve; and

(7) Lactococcus lactis subsp. lactis.

The fermented noni may be bioconverted to scopoletin, deacetylasperulosidic acid (DAA) and asperulosidic acid.

The contents of scopoletin, deacetylasperulosidic acid and asperulosidic acid, which are bioconverted in the fermented noni, are 1 to 200 μg/mL, 0.2 to 0.6 mg/L, and 0.096 to 1.41 mg/ml, respectively.

The present invention also provides a method for preparing a food composition for preventing and ameliorating diabetes, the method including: (S1) a step of preparing fermented noni bioconverted by inoculating lactic acid bacteria into noni fruit to ferment and age the noni fruit; and (S2) a step of juicing the fermented noni obtained by fermenting and aging the noni fruits.

The fermentation and aging may be performed at 35 to 40° C. for 168 hours or more.

The aging may be performed by pouring a fermentation broth produced in the fermentation process on top of a fermented product at regular time intervals.

The bioconverted fermented noni may be a fermented product in which one or more of the following 7 types of lactic acid bacteria are inoculated into noni fruit.

(1) Lactobacillus plantarum;

(2) Bifidobacterium lactis;

(3) Lactobacillus rhamnosus;

(4) Lactobacillus casei;

(5) Lactobacillus fermentum;

(6) Bifidobacterium breve; and

(7) Lactococcus lactis subsp. lactis.

The contents of scopoletin, deacetylasperulosidic acid and asperulosidic acid, which are bioconverted in the fermented noni, are 1 to 200 μg/mL, 0.2 to 0.6 mg/L, and 0.096 to 1.41 mg/ml, respectively.

### Advantageous Effects

The fermented noni included in the food composition for preventing and ameliorating diabetes according to the present invention has an effect of not only preventing diabetes but also lowering the blood glucose of existing patients with diabetes.

Furthermore, the fermented noni secretes an enzyme capable of improving digestion and absorption in the process of fermenting noni fruit, and thus promotes digestion and defecation activity for adults and elderly people with relatively poor digestion, and meanwhile, since the fermented noni is a natural raw material, the fermented noni has no toxicity and side effects, and thus has an effect of being safely ingested.

Further, since the process of preparing the fermented noni is simple, the preparation cost can be significantly reduced, and thus there is an effect that the purchasing cost burden on consumers can be significantly reduced.

### DESCRIPTION OF DRAWINGS

FIG. 1 is a component detection graph of a fermented noni fruit extract obtained in Example 1.

FIG. 2 is a graph showing the measurement results of fasting blood glucose for each experimental group according to Experimental Example 1.

FIG. 3 is a graph showing the measurement results of an oral glucose tolerance test for each experimental group according to Experimental Example 1.

FIG. 4 is a graph showing the area under curve (AUC) measurement results for each experimental group according to Experimental Example 1.

### MODES OF THE INVENTION

Hereinafter, the present invention will be described in more detail in order to help the understanding of the present invention.

Terms or words used in the specification and the claims should not be interpreted as being limited to typical or dictionary meanings and should be interpreted with a meaning and a concept that are consistent with the technical spirit of the present invention based on the principle that an inventor can appropriately define the concept of a term in order to describe his/her own invention in the best way.

Food Composition for Preventing and Ameliorating Diabetes

The present invention relates to a food composition for preventing and ameliorating diabetes, including fermented noni inoculated with lactic acid bacteria.

In the present invention, the fermented noni inoculated with lactic acid bacteria may be included in an amount of 1 to 10 wt %, preferably 2 to 8 wt %, and more preferably 3 to 6 wt % based on the total weight of the food composition. When the content is less than the above range, the blood glucose reduction effect is insignificant, and when the content exceeds the above range, the content of fermented noni increases, but the blood glucose reduction effect does not continuously increase.

In the present invention, the fermented noni is obtained by inoculating lactic acid bacteria into noni fruit and fermenting the noni fruit, and the lactic acid bacteria inoculated into the fermented noni may be complex lactic acid bacteria including at least one of the following 7 types of lactic acid bacteria.

(1) Lactobacillus plantarum;

(2) Bifidobacterium lactis;

(3) Lactobacillus rhamnosus;

(4) Lactobacillus casei;

(5) Lactobacillus fermentum;

(6) Bifidobacterium breve; and

(7) Lactococcus lactis subsp. lactis

In this case, a mixing ratio of the 7 types of lactic acid bacteria may be 60 to 65 wt % of Lactobacillus plantarum; 10 to 15 wt % of Bifidobacterium lactis; 1 to 10 wt % of Lactobacillus casei; 1 to 10 wt % of Lactobacillus fermentum; 1 to 10 wt % of Bifidobacterium breve; and 1 of 10 wt % of Lactococcus lactis subsp. lactis.

If even one of the mixing proportions of the 7 types of lactic acid bacteria does not satisfy the above range, the noni fruit may not be fermented properly, or even if the noni fruit is fermented, the taste and aroma may not reach a desired level. Further, although the noni fruit fermented by the complex lactic acid bacteria including the 7 types of lactic acid bacteria mixed by the mixing ratio have advantages in that a digestion-absorption rate and preservation are improved by an enzyme produced in the fermentation process and a substance that serves as a natural preservative, and thus the noni fruit can be stored for a long period of time, the aforementioned advantages may not be expressed when the complex lactic acid bacteria is out of the above mixing ratio.

As described above, the fermented noni exhibits an excellent effect of lowering blood glucose by bioconverting some of the physiologically active components included in the noni fruit through the process of being fermented by the complex lactic acid bacteria containing the 7 types of lactic acid bacteria, and thus fermented noni including a component exhibiting an excellent effect on lowering blood glucose may be obtained. In this case, bioconversion refers to the conversion of an added substance into a chemically modified form using the physiological function of the organism, and the following scopoletin, deacetylasperulosidic acid and asperulosidic acid refer to components in a form in which the absorption rate is improved by inoculation with lactic acid bacteria and the blood glucose lowering effect is complemented.

In other words, when lactic acid bacteria including all of the 7 types of lactic acid bacteria are inoculated, fermented noni is obtained in the form of including scopoletin, deacetylasperulosidic acid and asperulosidic acid by bioconversion, and further, these three components may be included in a content range that has a significant effect on lowering blood glucose.

The contents of scopoletin, deacetylasperulosidic acid and asperulosidic acid, which are included in the fermented noni, may be 1 to 200 μg/mL, 0.2 to 0.6 mg/L, and 0.096 to 1.41 mg/ml, respectively.

The contents of scopoletin, deacetylasperulosidic acid and asperulosidic acid included in the fermented noni as described above are in a content range when the blood glucose reduction effect is most evident, and when the content is out of the above range, the degree of reduction in blood glucose may be insignificant.

That is, when the scopoletin, deacetylasperulosidic acid and asperulosidic acid as described above are contained in the fermented noni as mentioned above, the blood glucose lowering effect may be the best.

As used herein, ‘food composition’ refers to a natural product or processed product containing one or more nutrients, preferably refers to a state in which the food can be directly eaten after undergoing some processing processes, and refers to all foods, food additives, functional food and beverages in a typical sense.

Also, ‘food composition for prevention and amelioration’ refers to a food processed and designed so as to sufficiently express the function of in vivo regulation related to the regulation of the biological defense rhythm, disease prevention, recovery and the like of a food group or food composition to which an added value is imparted such that the function of the food acts and is expressed for a specific purpose using physical, biochemical bioengineering techniques and the like for the corresponding food.

Examples of the food composition for preventing and ameliorating diabetes according to the present invention include various foods, beverages, gums, teas, vitamin complex agents, functional foods and the like. Furthermore, the present invention may contain various nutrients, vitamins, minerals (electrolytes), flavoring agents such as synthetic flavoring agents and natural flavoring agents, colorants, fillers (cheese, chocolate, and the like), pectic acid and salts thereof, alginic acid and salts thereof, organic acids, protective colloid thickeners, pH adjusting agents, stabilizers, preservatives, glycerin, alcohols, carbonating agents used in a carbonated beverage, or the like, and the ingredients may be used independently or in combination. The component may be added in an appropriate amount within a range that does not impair the diabetes preventive and ameliorating effect of fermented noni. For example, the component may be included in an amount of 0.1 to 1 wt % based on the total weight of the food composition.

Further, the composition for preventing and ameliorating diabetes may include a sitologically acceptable food auxiliary additive, and may further include appropriate carriers, excipients and diluents typically used for the preparation of the food composition for prevention and amelioration.

Since the food composition for preventing and ameliorating diabetes of the present invention can be formulated in various forms, the form thereof is not particularly limited. Preferably, the food composition for preventing and ameliorating diabetes may be formed into any one formulation selected from beverages, granules, tablets, powders, pills and capsules.

Food compositions for prevention and amelioration with such forms of beverages, granules, tablets, powders, pills and capsules are easily carried and easily taken anytime and anywhere.

The present invention also relates to a method for preparing a food composition for preventing and ameliorating diabetes, and may include: (51) a step of fermenting and aging noni fruit by inoculating lactic acid bacteria into the noni fruit; and (S2) a step of juicing the fermented noni obtained by fermenting and aging the noni fruit.

Hereinafter, the method for preparing a food composition for preventing and ameliorating diabetes according to the present invention at each step will be described in more detail.

Step (S1) In Step (51), noni fruit may be fermented and aged by inoculating lactic acid bacteria into the noni fruit.

In the present invention, lactic acid bacteria used to ferment the noni fruit may be complex lactic acid bacteria including one or more of the following 7 types of lactic acid bacteria.

(1) Lactobacillus plantarum;

(2) Bifidobacterium lactis;

(3) Lactobacillus rhamnosus;

(4) Lactobacillus casei;

(5) Lactobacillus fermentum;

(6) Bifidobacterium breve; and

(7) Lactococcus lactis subsp. lactis

In this case, a mixing ratio of the 7 types of lactic acid bacteria may be 60 to 65 wt % of Lactobacillus plantarum; 10 to 15 wt % of Bifidobacterium lactis; 1 to 10 wt % of Lactobacillus casei; 1 to 10 wt % of Lactobacillus fermentum; 1 to 10 wt % of Bifidobacterium breve; and 1 of 10 wt % of Lactococcus lactis subsp. lactis.

Preferably, when complex lactic acid bacteria including all of the 7 types of lactic acid bacteria is inoculated into noni, fermented noni including all of scopoletin, deacetylasperulosidic acid and asperulosidic acid in a content range which exhibits a significant effect on blood glucose lowering can be obtained. The contents of the three components included in the fermented noni are as described above.

If even one of the mixing proportions of the 7 types of lactic acid bacteria does not satisfy the above range, the noni fruit may not be fermented properly, or even if the noni fruit is fermented, the taste and aroma may not reach a desired level. Further, although the noni fruit fermented by the complex lactic acid bacteria including the 7 types of lactic acid bacteria mixed by the mixing ratio have advantages in that a digestion-absorption rate and preservation are improved by an enzyme produced in the fermentation process and a substance that serves as a natural preservative, and thus the noni fruit can be stored for a long period of time, the aforementioned advantages may not be expressed when the complex lactic acid bacteria is out of the above mixing ratio.

The lactic acid bacteria may be inoculated into noni fruit in the form of a lactic acid bacteria solution, preferably an aqueous solution of lactic acid bacteria. In this case, 1 to 3 parts by weight of the lactic acid bacteria solution may be inoculated with respect to 100 parts by weight of the noni fruit. When the inoculation amount of such a lactic acid bacteria solution is satisfied, the bioconversion as described above is smoothly performed, and fermented noni with a component exhibiting a significant effect on blood glucose lowering may be obtained.

In the present invention, the fermentation and aging may be performed at 35 to 40° C. for 168 hours or more. Specifically, the fermentation may prevent the formation of mold and may homogenize the fermentation broth by performing fermentation and aging for 168 hours or more from the fermentation start date.

The fermentation and aging temperature may be 35 to 40° C. When the fermentation and aging temperature is less than 30° C., fermentation may not be performed normally, and when the temperature exceeds 40° C., the fermentation and aging time is prolonged, so lactic acid bacteria may die, or the taste and aroma of noni beverages may deteriorate.

In the present invention, the aging may be performed by pouring a fermentation broth produced in the fermentation process on top of a fermented product at regular time intervals.

By performing aging in this way, a bitter taste and the like may be removed and the taste may be homogenized. Preferably, the noni fruit may be aged by pouring the fermentation broth on top of the fermented product at intervals of 5 days to 10 days. When the interval of pouring the fermentation broth on top of the fermented product was an interval of 5 days or less (for example, 3 days) or 10 days or more (for example, 11 days), a bitter taste lingered.

Step (S2)

In Step (S2), the fermented noni obtained by fermenting and aging the noni fruit may be juiced. In this case, the fermented noni that has been subjected to the fermentation and aging processes may include both noni fruit and a fermentation broth.

Meanwhile, a step of pre-heating the fermented noni may be further included before the juicing step.

The preheating may be performed by heating the fermented noni at a low temperature, and the preheating may soften the fiber of the fermented noni to increase the juicing yield, and may allow nutrients from the noni fruit included in the fermented noni to be well extracted.

In this case, the preheating temperature is preferably 70 to 80° C. When the preheating temperature is less than 60° C., the effect of improving the juicing yield cannot be expected because there is no change in the fibrous state in the fermented noni, and when the preheating temperature exceeds 80° C., the fermented noni may be denatured, or lactic acid bacteria in the fermented noni may be sterilized. In particular, when the preheating temperature is 90° C. or higher, there is a problem in that 90% or more of lactic acid bacteria are sterilized.

In addition, the preheating time is preferably 1 hour to 2 hours. When the preheating time is less than 30 minutes, the effect of improving the juicing yield cannot be expected because there is no change in the fibrous state in the fermented noni, and when the preheating time exceeds 2 hours, the fermented noni may be denatured, or lactic acid bacteria in the fermented noni may die.

For juicing, a beverage may be prepared by juicing the noni fruit included in the fermented noni or the fermentation broth.

In this case, juicing may be carried out by applying pressure to the fermented noni, and the appropriate pressure during juicing is preferably 0.05 to 7 bar. When the pressure during juicing is less than 0.05 bar, the yield during the production of a noni beverage may decrease because juicing is not performed properly, and when the pressure during juicing exceeds 7 bar, the purity of the noni beverage may be reduced because the by-products of noni fruit are mixed together.

Further, after the juicing, filtration and sterilization processes may be further performed to improve the purity and enhance the reliability of the product.

The filtration may be performed using a filtration net having a pore diameter size of 10 to 30 mesh. When the pore diameter size of the filtration net is less than 10 mesh, process efficiency may be reduced, and when the pore diameter size exceeds 30 mesh, by-products may still be included in the filtered noni beverage.

The sterilization is not limited as lo ng as it is a general sterilization method in the art and can be used widely.

Hereinafter, preferred examples will be provided to help understand the present invention, but the following Examples are only provided to illustrate the present invention, and it is apparent to those skilled in the art that various alterations and modifications are possible within the scope and technical spirit of the present invention, and it goes with saying that such alterations and modifications also fall within the accompanying claims.

### EXAMPLE 1

690 kg of noni fruit was inoculated with a lactic acid bacteria solution (10.3 kg) and fermented at 37° C. for 30 days. In this case, when the inoculation amount of the lactic acid bacteria solution is converted into parts by weight, the amount is 1.49 parts by weight with respect to 100 parts by weight of the noni fruit.

The lactic acid bacteria solution includes a complex of 7 types of lactic acid bacteria (LACTOMASON Co., Ltd.). Every 7 days from the start date of fermentation, 10 L of the fermentation broth was collected, transferred and poured on top of the noni fruit, and fermentation and aging were performed to prepare fermented noni.

In this case, based on 100%, the composition of the complex of 7 types of lactic acid bacteria used is shown in the following Table 1.

TABLE 1

| No. | Complex lactic acid bacteria component | Blending ratio |
|---|---|---|
| 1 | Lactobacillus plantarum KCCM11821P | 63% |
| 2 | Bifidobacterium lactis | 12% |
| 3 | Lactobacillus rhamnosus | 5% |
| 4 | Lactobacillus casei | 5% |
| 5 | Lactobacillus fermentum | 5% |
| 6 | Bifidobacterium breve | 5% |
| 7 | Lactococcus lactis subsp. lactis | 5% |

The fermented noni was preheated at 78° C. for 1 hour and 30 minutes, and then juiced at a pressure of 4 bar using a juicer.

Thereafter, after the juice was filtered and sterilized using a 20 mesh filtration net and mixed with purified water, a food composition having a fermented noni content of 5 wt % was prepared.

### COMPARATIVE EXAMPLES 1 to 5

A fermented noni-containing food composition was prepared in the same manner as in Example 1 except that the complex lactic acid bacteria components included 2 types, 3 types, 4 types, 5 types and 6 types, respectively, as shown in the following Table 2.

TABLE 2

| | | Comparative | Comparative | Comparative | Comparative | Comparative |
|---|---|---|---|---|---|---|
| | Complex lactic | Example 1 | Example 2 | Example 3 | Example 4 | Example 5 |
| | acid bacteria | 2 types | 3 types | 4 types | 5 types | 6 types |
| No. | components | Blending ratio | | | | |
| 1 | Lactobacillus | 80% | 80% | 75% | 70% | 65% |
| | plantarum | | | | | |
| | KCCM11821P | | | | | |
| 2 | Bifidobacterium | 20% | 15% | 15% | 15% | 15% |
| | lactis | | | | | |
| 3 | Lactobacillus | — | 5% | 5% | 5% | 5% |
| | rhamnosus | | | | | |
| 4 | Lactobacillus | — | — | 5% | 5% | 5% |
| | casei | | | | | |
| 5 | Lactobacillus | — | — | — | 5% | 5% |
| | fermentum | | | | | |
| 6 | Bifidobacterium | — | — | — | — | 5% |
| | breve | | | | | |
| 7 | Lactococcus | — | — | — | — | — |
| | lactis subsp. | | | | | |
| | lactis | | | | | |

### EXPERIMENTAL EXAMPLE 1

### Analysis of Components in Fermented Noni

A component analysis of the fermented noni prepared in Example 1 was performed, and the analysis method is as follows.
Column: Symmetry C18 (Waters, 4.6×250 mm, I.D)
Solvent condition: Gradient condition using distilled water containing 0.1% (v/v) formic acid and methanol
Flow rate: 1.0 ml/min
UV detector: 254 nm

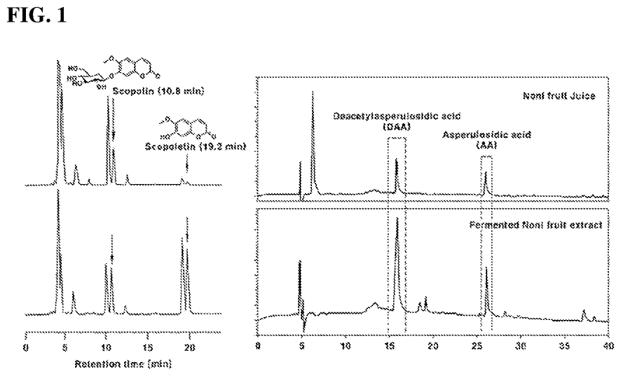

FIG. 1 is a component detection graph of a fermented noni fruit extract obtained in Example 1.

Referring to FIG. 1, it can be seen that scopoletin, deacetylasperulosidic acid and asperulosidic acid are included in the fermented noni obtained in Example 1.

In addition, component analysis of fermented noni of Comparative Examples 1 to 5 was also performed in the same manner as described above, and the contents of each component are shown in Table 3 for comparison.

TABLE 3

| Fermented noni | | Comparative | Comparative | Comparative | Comparative | Comparative |
|---|---|---|---|---|---|---|
| component content | Example 1 | Example 1 | Example 2 | Example 3 | Example 4 | Example 5 |
| Scopoletin (μg/mL) | 103 | 53 | 54 | 65 | 65 | 71 |
| Deacetylasperulosidic | 0.5 | 0.02 | 0.01 | 0.02 | 0.08 | 0.3 |
| acid (mg/L) | | | | | | |
| Asperulosidicacid | 0.7 | 0 | 0.02 | 0.07 | 0.06 | 0.005 |
| (mg/ml) | | | | | | |

From the results in Table 3, it can be seen that when fermentation was performed using less than 7 types of lactic acid bacteria in the inoculated complex lactic acid bacteria during the preparation of the fermented noni, a case where one or more components of the three components are significantly low or absent occurred.

### EXPERIMENTAL EXAMPLE 2

### In Vivo Efficacy Test for Blood Glucose Lowering of Food Composition

As shown in the following Table 2, an in vivo efficacy test for blood glucose lowering was performed by setting 4 types of diabetic and non-diabetic models.

(2-1) Product Dose and Administration Method

As in the following Table 4, experimental target animals are a model of 6-week-old male C57BL/KsJ db/db diabetic mice (diabetic model, hereinafter, referred to as db/db mice) and non-diabetic C57BL/KsJ m+/db mice (non-diabetic model, hereinafter, referred to as m+/db mice) in which blood glucose is continuously increased up to 12 to 15 weeks.

An administration sample administered to a diabetic model positive control was a Metformin Tab (metformin hydrochloride, JRP), which is a diabetic drug. A dose was 200 mg/kg body weight of a mouse (denoted as Metformin 200 mg/kg).

An administration sample administered to a diabetic model fermented noni group was a food composition containing the fermented noni obtained in Example 1. A dose was 100 mg/kg body weight of a mouse (denoted as Noni 100 mg/kg).

As for the administration method, each administration sample was dissolved in 0.5% carboxymethyl cellulose (CMC) for each dose and orally administered once a day for 6 weeks.

TABLE 4

| | Experimental | Administration | |
|---|---|---|---|
| Experimental group | animal | sample | Denoted |
| Non-diabetic model | non-diabetic | — | m+/db |
| control | C57BL/KsJ | | |
| | m+/db mice | | |
| Diabetic model | C57BL/KsJ db/db | — | db/db |
| control | diabetic mice | | |
| Diabeticmodel | C57BL/KsJ db/db | Metformin 200 | Metformin |
| positive control | diabetic mice | mg/kg | 200 mg/kg |
| Group | | | |
| Diabeticmodel | C57BL/KsJ db/db | 100 mg/kg food | Noni 100 |
| fermented noni | diabetic mice | composition | mg/kg |
| Group | | containing | |
| | | fermented noni in | |
| | | Example 1 | |

(2-2) Body Weight Gain and Changes in Diet and Water Intakes of Experimental Animals

Body weight gain and changes in diet and water intakes of the experimental animals were measured every 3 days.

As a result, for the body weight gain of the experimental animals, the weight gain was shown to be relatively low in a diabetic model fermented noni group (Noni 100 mg/kg) and a non-diabetic model positive control (Metformin 200 mg/kg) compared to a diabetic model control (db/db mice) showing a tendency to increase every 3 days.

In addition, although there were differences in food intake and water intake for each group between the non-diabetic model control (m+/db) and the diabetic model control (db/db), it was found that there was almost no difference among the diabetic model control (db/db), the diabetic model positive control (Metformin 200 mg/kg) and the diabetic model fermented noni group (Noni 100 mg/kg).

(2-3) Measurement of Fasting Blood Glucose

The fasting blood glucose of the experimental animals was measured once a week for 6 weeks using a glucometer. Fasting blood glucose was measured at 1-week (7-day) intervals for 6 weeks (42 days) for each experimental group.

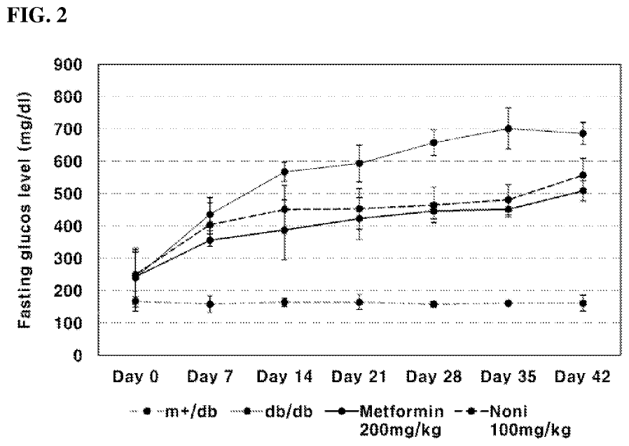

FIG. 2 is a graph showing the measurement results of fasting blood glucose for each experimental group according to Experimental Example 1.

Referring to FIG. 2, it was found that in the case of fasting blood glucose, the diabetic model control (db/db) showed the highest blood glucose level at week 5 and then maintained a high blood glucose level until week 6.

In addition, the diabetic model positive control (Metformin 200 mg/kg) and the diabetic model fermented noni group (Noni 100 mg/kg) showed consistently low fasting blood glucose for 1 to 6 weeks.

Meanwhile, after 6 weeks, the diabetic model fermented noni group (Noni 100 mg/kg) was shown to have a blood glucose lowering effect due to a 25% decrease in fasting blood glucose, and the diabetic model positive control (Metformin 200 mg/kg) was shown to have a 34% decrease in fasting blood glucose.

It can be seen that such a fasting blood glucose reduction effect is similar even though there is a difference in the dose of the administered sample between the diabetic model fermented noni group (Noni 100 mg/kg) and the diabetic model positive control (Metformin 200 mg/kg).

(2-4) Oral Glucose Tolerance Test (OGTT)

After the completion of oral administration for 6 weeks, an oral glucose tolerance test (OGTT) was performed.

After experimental animals were fasted for 12 hours, fasting blood glucose was measured by collecting blood from the tail vein, and then a 50% glucose solution (3.0 g/kg of B.W) was orally administered to all groups, and after 30 minutes, 60 minutes, 120 minutes and 180 minutes, blood glucose was measured using a glucometer.

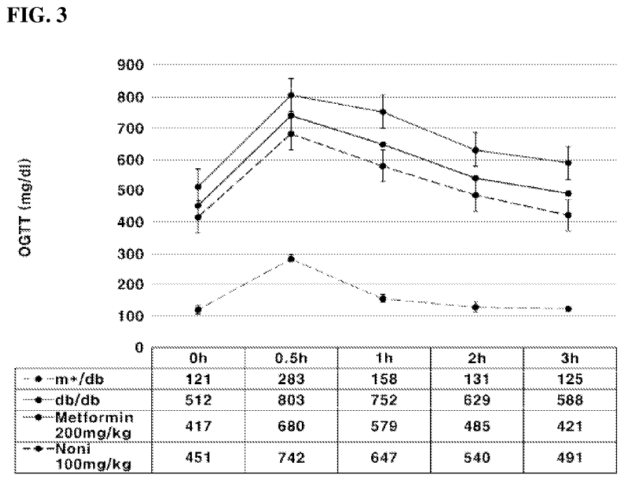

FIG. 3 is a graph showing the measurement results of an oral glucose tolerance test for each experimental group according to Experimental Example 1.

Referring to FIG. 3, normal blood glucose increased to the highest level after 30 minutes (0.5 hr), and at this time, the highest value was shown in the diabetic model control (db/db).

The blood glucose level started to decrease from 1 hr, and compared to blood glucose increased at 0.5 hr in the diabetic model control (db/db), it was found that blood glucose was decreased by 33.1% and 13.9% in the diabetic model positive control (Metformin 200 mg/kg) and the diabetic model fermented noni group (Noni 100 mg/kg), respectively.

Further, at 2 hr, it was found that blood glucose was decreased by 22.9% and 14.2% in the diabetic model positive control (Metformin 200 mg/kg) and the diabetic model fermented noni group (Noni 100 mg/kg), respectively, compared to the diabetic model control (db/db).

In addition, at 3 hr, it was found that blood glucose was decreased by 28.5% and 16.5% in the diabetic model positive control (Metformin 200 mg/kg) and the diabetic model fermented noni group (Noni 100 mg/kg), respectively, compared to the diabetic model control (db/db).

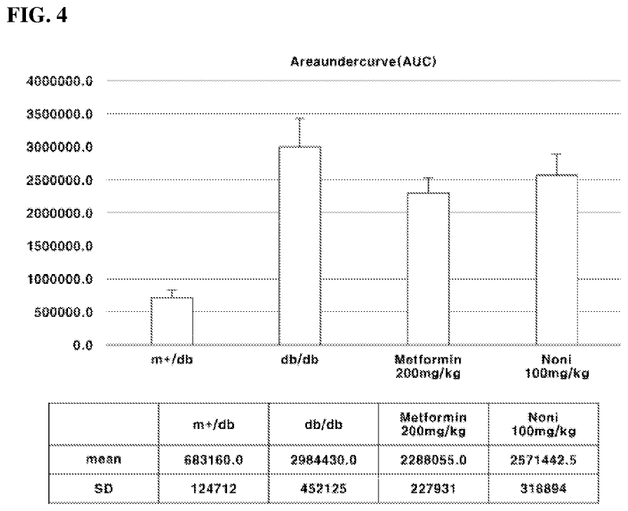

FIG. 4 is a graph showing the area under curve (AUC) measurement results for each experimental group according to Experimental Example 1.

Referring to FIG. 4, the AUC value in the diabetic model control (db/db) was increased 6.9-fold compared to the non-diabetic model control (m+/db).

Furthermore, it was found that the AUC value was decreased by 23.3% and 13.8% in the diabetic model positive control (Metformin 200 mg/kg) and the diabetic model fermented noni group (Noni 100 mg/kg), respectively, compared to the diabetic model control (db/db).

As described above, although the present invention is described by the limited embodiments and drawings, the present invention is not limited thereby, and it goes without saying that various modifications and variations can be made by a person with ordinary skill in the art to which the present invention pertains within the technical spirit of the present invention and the equivalent scope of the claims to be described below.

1. A food composition for preventing and ameliorating diabetes, comprising fermented noni inoculated with lactic acid bacteria.

2. The food composition of claim 1, wherein the fermented noni inoculated with lactic acid bacteria is comprised in an amount of 1 to 10 wt % based on a total weight of the food composition.

3. The food composition of claim 1, wherein the fermented noni is a fermented product in which one or more of the following 7 types of lactic acid bacteria are inoculated into noni fruit:
(1) Lactobacillus plantarum;
(2) Bifidobacterium lactis;
(3) Lactobacillus rhamnosus;
(4) Lactobacillus casei;
(5) Lactobacillus fermentum;
(6) Bifidobacterium breve; and
(7) Lactococcus lactis subsp. Lactis.

4. The food composition of claim 1, wherein the fermented noni is bioconverted to scopoletin, deacetylasperulosidic acid and asperulosidic acid.

5. The food composition of claim 4, wherein the contents of scopoletin, deacetylasperulosidic acid and asperulosidic acid, which are bioconverted in the fermented noni, are 1 to 200 μg/mL, 0.2 to 0.6 mg/L, and 0.096 to 1.41 mg/ml, respectively.

6. A method for preparing a food composition for preventing and ameliorating diabetes, the method comprising: (S1) a step of preparing fermented noni bioconverted by inoculating lactic acid bacteria into noni fruit to ferment and age the noni fruit; and
(S2) a step of juicing the fermented noni obtained by fermenting and aging the noni fruit.

7. The method of claim 6, wherein the fermentation and aging are performed at 35 to 40° C. for 168 hours or more.

8. The method of claim 6, wherein the aging is performed by pouring a fermentation broth produced in the fermentation process on top of a fermented product at regular time intervals.

9. The method of claim 6, wherein the bioconverted fermented noni is a fermented product in which one or more of the following 7 types of lactic acid bacteria are inoculated into noni fruit:
(1) Lactobacillus plantarum;
(2) Bifidobacterium lactis;
(3) Lactobacillus rhamnosus;
(4) Lactobacillus casei;
(5) Lactobacillus fermentum;
(6) Bifidobacterium breve; and
(7) Lactococcus lactis subsp. Lactis.

101. The method of claim 6, wherein the contents of scopoletin, deacetylasperulosidic acid and asperulosidic acid, which are bioconverted in the fermented noni, are 1 to 200 μg/mL, 0.2 to 0.6 mg/L, and 0.096 to 1.41 mg/ml, respectively.
